(19) United States
(12) Patent Application Publication
(10) Pub. No.: US 2024/0116364 A1
(43) Pub. Date: Apr. 11, 2024

(54) VIRTUAL IMAGE DISPLAY APPARATUS

(71) Applicant: DENSO CORPORATION, Kariya-city (JP)

(72) Inventors: Yasunori NINOMIYA, Kariya-city (JP); Syunichi Okada, Obu-city (JP); Yusuke Ohta, Obu-city (JP); Kenta Futamura, Obu-city (JP)

(21) Appl. No.: 18/390,128

(22) Filed: Dec. 20, 2023

Related U.S. Application Data
(63) Continuation of application No. PCT/JP2022/026611, filed on Jul. 4, 2022.

(30) Foreign Application Priority Data
Jul. 9, 2021 (JP) 2021-114361

(51) Int. Cl. B60K 35/231

(52) U.S. Cl. CPC B60K 35/231; B60K 2360/334

(57) ABSTRACT

A virtual image display apparatus includes a housing having a first housing part and a second housing part. The first housing part is located on a side facing in a first direction. The second housing part is located on a side facing in a second direction being opposite to the first direction. A composite wall is located at the housing on a side facing in a third direction being perpendicular to the first direction. The composite wall includes a first front wall portion and a second front wall portion. The first front wall portion is extended from the first housing part. The second front wall portion is extended from the second housing part. The first and second front wall portions have an interference avoidance structure that avoids interference when the first and second front wall portions approach each other by receiving a load.

### CROSS REFERENCE TO RELATED APPLICATIONS

The present application is a continuation application of International Patent Application No. PCT/JP2022/026611 filed on Jul. 4, 2022, which designated the U.S. and claims the benefit of priority from Japanese Patent Application No. 2021-114361 filed on Jul. 9, 2021. The entire disclosures of all of the above applications are incorporated herein by reference.

### TECHNICAL FIELD

The present disclosure relates to a virtual image display apparatus.

### BACKGROUND

A virtual image display apparatus may emit display light towards a projection member of a vehicle body, so that a viewer may visually recognize the display light as a virtual image reflected at the projection member.

### SUMMARY

The present disclosure describes a virtual image display apparatus including a housing having a composite wall.

### BRIEF DESCRIPTION OF DRAWINGS

FIG. 1 illustrates a state in which a virtual image display apparatus according to a first embodiment is adapted to a vehicle.

FIG. 2 is a perspective view showing the appearance of the virtual image display apparatus according to the first embodiment.

FIG. 3 is a top view showing the appearance of the virtual image display apparatus according to the first embodiment.

FIG. 4 is a perspective view of a cross-sectional view taken along IV-IV in FIG. 2.

FIG. 5 is a schematic diagram of a cross-sectional view seen from above in the first embodiment.

FIG. 6 is a schematic diagram of a cross-sectional view from a lateral side of a virtual image display apparatus according to a second embodiment.

FIG. 7A is an explanatory diagram showing an interference avoidance structure in the second embodiment.

FIG. 7B is an explanatory diagram showing another interference avoidance structure in the second embodiment.

FIG. 8 is a schematic diagram of a cross-sectional view seen from a lateral side of a virtual image display apparatus according to a modified example in which the upper end of a first front wall portion is located below a rotation shaft.

FIG. 9 is a schematic diagram of a cross-sectional view seen from a lateral side of a virtual image display apparatus according to a modified example in which a second front wall portion is further away from a plane where the first front wall portion is located as approaching to the lower side of the second front wall portion.

FIG. 10 is a schematic diagram of a cross-sectional view seen from a lateral side of a virtual image display apparatus according to a modified example in which ribs are provided.

FIG. 11A is a cross-sectional view of a rib with a concave curved surface.

FIG. 11B is a cross-sectional view of a rib with a convex curved surface.

FIG. 11C is a cross-sectional view of a stepped rib.

FIG. 11D is a cross-sectional view of a rib with a protrusion.

FIG. 12 is a schematic diagram of a cross-sectional view from a lateral side of a virtual image display apparatus according to a modified example in which the upper end of the first front wall portion and the lower end of the second front wall portion are arranged at positions that do not overlap in the up-down direction.

### DETAILED DESCRIPTION

In a virtual image display apparatus, a mounting portion provided on a housing of the virtual image display apparatus may be fixed to a bracket portion provided on a vehicle body with bolts. The mounting portion may be provided with a notch. The notch is connected to the mounting hole through which the bolt is inserted, and opens towards the front side of the vehicle body to enable the movement of the mounting portion with respect to the bolt in the event of a pedestrian running into the vehicle body. Due to the provision of the notch, in the event of a pedestrian running into the vehicle body, the mounting portion may slide rearward due to an external force directed towards the rear side and is unfixed by the bolt, and the virtual image display apparatus may slip out of the bracket portion. Therefore, the impact given to the pedestrian who runs into the vehicle may be reduced.

However, the following issues have been found by the inventors of the present application. Although the virtual image display apparatus may attempt to suppress impact by focusing only on rearward movement, it may be desirable that the impact absorption function can also be exerted in the up-down direction.

According to an aspect of the present disclosure, a virtual image display apparatus emits display light towards a projection member of a vehicle to allow a viewer to visually recognize the display light as a virtual image reflected by the projection member. The virtual image display apparatus includes a housing having a first housing part, a second housing part, and a composite wall. The first housing part is located on a side of the housing facing in a first direction. The second housing part is located on a side of the housing facing in a second direction being opposite to the first direction. The composite wall is located on a side of the housing facing in a third direction being perpendicular to the first direction. The composite wall includes a first wall portion and a second wall portion. The first wall portion is extended from the first housing part, and the second wall portion is extended from the second housing part. The first wall portion and the second wall portion have an interference avoidance structure that avoids interference when the first wall portion and the second wall portion approach each other by receiving a load.

According to such a configuration, it is possible to absorb impact at a higher degree.

Several embodiments of the present disclosure will be described below with reference to the drawings.

### First Embodiment

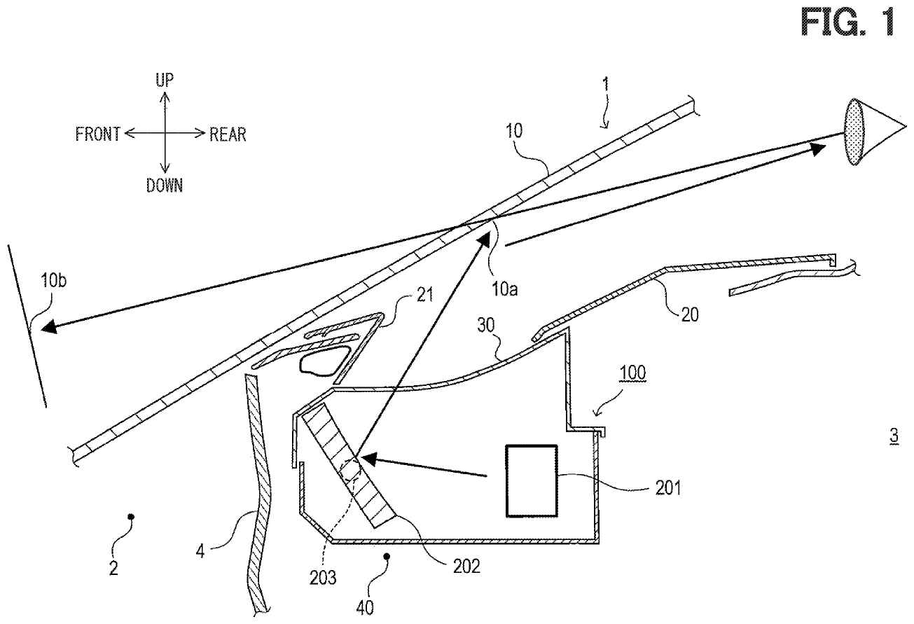

As shown in FIG. 1, a virtual image display apparatus 100 is adapted to, for example, a vehicle such as an automobile. The virtual image display apparatus 100 is an apparatus that emits display light towards the windshield 10 of a vehicle so that a viewer can visually recognize the display light reflected by the windshield 10 as a virtual image 10b. The virtual image display apparatus 100 is provided below a windshield 10. In this embodiment, the virtual image display apparatus 100 is stored in a space 40 formed by an instrument panel 20 provided in a vehicle body 1 and a partition wall 4 that partitions an engine compartment 2 and a vehicle compartment 3. Hereinafter, in the description of the virtual image display apparatus 100, when the virtual image display apparatus 100 is attached to a vehicle, the front-rear direction with respect to the vehicle is regarded as the front-rear direction of the virtual image display apparatus 100; and the vehicle width direction with respect to the vehicle is regarded as the left-right direction of the virtual image display apparatus 100; and the up-down direction with respect to the vehicle is regarded as the up-down direction with respect to the virtual image display apparatus 100. The definition of direction is merely used for explanation and is not intended to limit the embodiments of the present disclosure. The up-down direction may also be referred to as a vertical direction.

The virtual image display apparatus 100 has a housing 30. For example, a display 201 and a concave mirror 202 are stored in the housing 30 of the virtual image display apparatus 100.

The virtual image display apparatus 100 reflects display light representing display information emitted from the display 201 on the concave mirror 202, and the reflected display light is incident on a projection position of the windshield 10 provided in the vehicle body 1 through an opening 21 formed at the instrument panel 20. The concave mirror 202 has a rotation shaft 203 that makes the concave mirror 202 rotatable. The virtual image display apparatus 100 forms a display image corresponding to display information on a front side of the windshield 10, so that a driver can visually recognize the display image as a virtual image 10b. The driver can visually recognize the displayed image and the foreground of the vehicle in a superimposed manner.

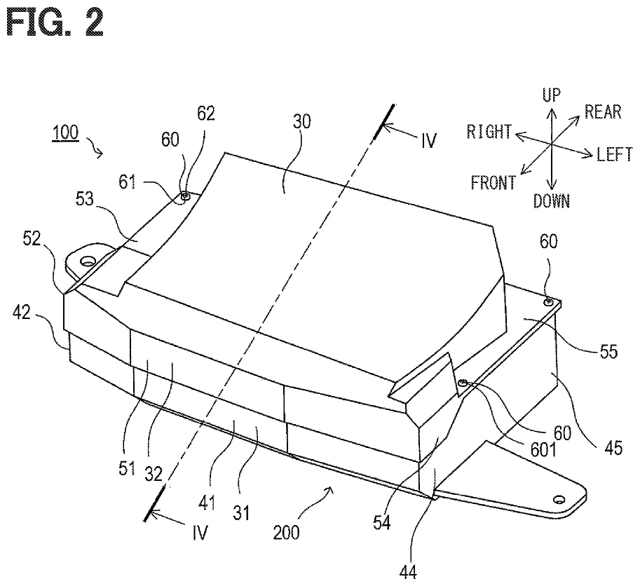

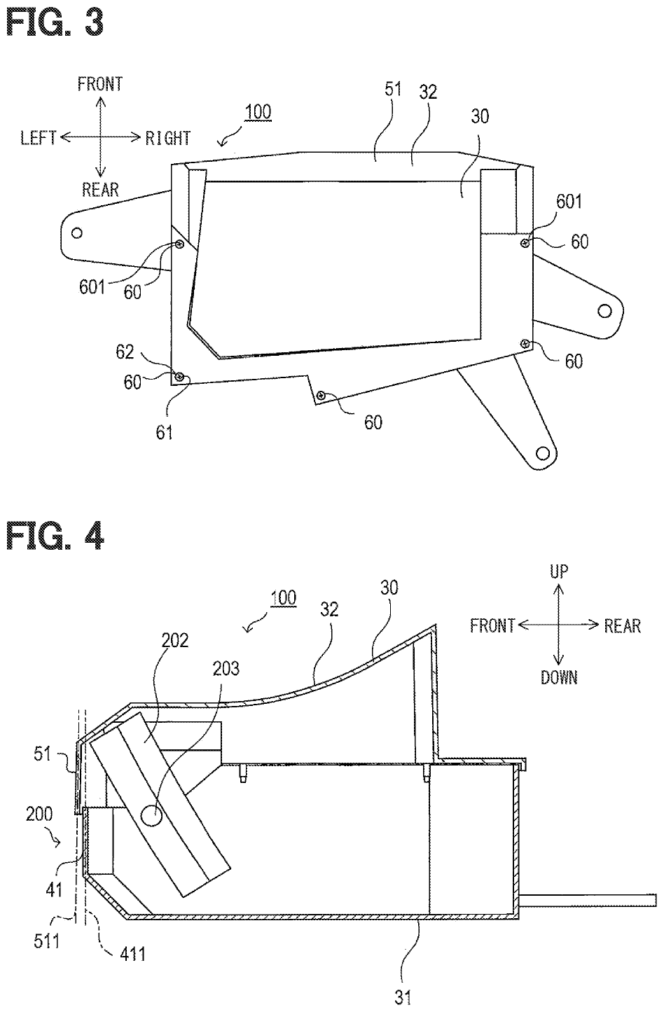

As shown in FIGS. 2 and 3, the housing 30 includes a first housing 31 and a second housing 32. The first housing 31 and the second housing 32 are made of resin material. The first housing 31 is located below the second housing 32. The first housing 31 may also be referred to as a first housing part, and the second housing 32 may also be referred to as a second housing part.

A composite wall 200 is formed on the front side of the housing 30. The composite wall 200 is a wall surface formed by a combination of a part of the first housing 31 and a part of the second housing 32. The composite wall 200 includes a first front wall portion 41, a first right wall portion 42, a first left wall portion 44, a second front wall portion 51, a second right wall portion 52, and a second left wall portion 54. The first front wall portion 41 and the second front wall portion 51 form a wall surface of the virtual image display apparatus 100 on a front side, and the first left wall portion 44 and the second left wall portion 54 form a wall surface being the left side surface of the virtual image display apparatus 100 on the front side. Although not shown in FIG. 2, the first right wall portion 42 and the second right wall portion 52 form a wall surface being the right side surface of the virtual image display apparatus 100 on the front side.

A first front wall portion 41 is formed on the front side of the first housing 31. The first front wall portion 41 is a wall extending from the lower side of the first housing 31 to the upper side of the first housing 31. The second front wall portion 51 is formed on the front side of the second housing 32. The second front wall portion 51 is a wall extending from the upper side of the second housing 32 to the lower side of the second housing 32. That is, the first front wall portion 41 and the second front wall portion 51 form the front wall of the housing 30. As shown in FIG. 4, the upper end of the first front wall portion 41 is provided above the height position of the rotating shaft 203.

The first front wall portion 41 and the second front wall portion 51 have an interference avoidance structure that avoids interference when they approach each other under a load. In the present embodiment, the first front wall portion 41 and the second front wall portion 51 are arranged at different positions in the thickness direction of the first front wall portion 41 and the second front wall portion 51 as an interference avoidance structure. That is, the first front wall portion 41 and the second front wall portion 51 are arranged at different positions in the front-rear direction, and there is a gap formed between the first front wall portion 41 and the second front wall portion 51 in the front-rear direction. The second front wall portion 51 protrudes further to the front side than the first front wall portion 41. The first front wall portion 41 and the second front wall portion 51 partially overlap in the up-down direction. A plane 411 on which the first front wall portion 41 is located and a plane 511 on which the second front wall portion 51 is located are substantially parallel. The plane 411 on which the first front wall portion 41 is located is a virtual plane that coincides with the plate-shaped first front wall portion 41. The plane 511 on which the second front wall portion 51 is located is a virtual plane that coincides with the plate-shaped second front wall portion 51.

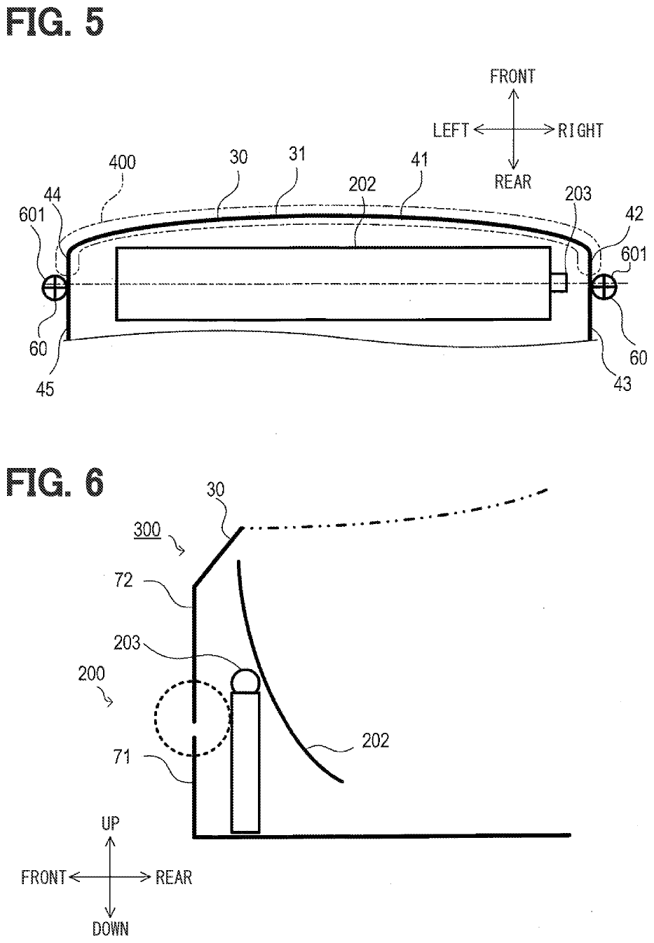

As shown in FIGS. 2 and 3, the first housing 31 and the second housing 32 are fixed by multiple fastening parts 60. Each of the fastening parts 60 includes a hole 61 and a fastener 62. The hole 61 is a through hole provided at the second housing 32. The fastener 62 penetrates the hole 61 and is fastened to the first housing 31. As a result, the second housing 32 is held between the fastener 62 and the first housing 31. In the present embodiment, the hole 61 is provided at an end portion of the second housing 32 when viewed from above. A screw is used as the fastener 62. As shown in FIG. 5, the two frontmost fastening portions 601 among the fastening parts 60 are provided behind the rotating shaft 203. Specifically, the center portions of the two fastening portions 601 are provided behind the rotating shaft 203. All of the fastening parts 60 are formed on the opposite side of the first front wall portion 41 and the second front wall portion 51 with the rotating shaft 203 located between: (i) the fastening parts 60; and (ii) the first wall portion 41 and the second front wall portion 51. In other words, there is no any member fastening the first housing 31 and the second housing 32 between the rotation shaft 203 and each of the first front wall portion 41 and the second front wall portion 51.

As shown in FIGS. 2, 5, the first housing 31 includes a first right wall portion 42, a first right surrounding portion 43, a first left wall portion 44, and a first left surrounding portion 45.

The first right wall portion 42 is a portion of the right wall surface of the first housing 31 that is on a front side of the two fastening portions 601. The portion being on a front side of the two fastening portions 601 refers to a portion being on a front side of a tip portion of the two fastening portions 601 on the front side. The first right surrounding portion 43 is a portion of the right wall surface of the first housing 31 that is behind of the two fastening portions 601.

The first left wall portion 44 is a portion of the left wall surface of the first housing 31 that is on a front side of the two fastening portions 601. The first left surrounding portion 45 is a portion of the left wall surface of the first housing 31 that is behind of the two fastening portions 601.

The second housing 32 includes a second right wall portion 52, a second right surrounding portion 53, a second left wall portion 54, and a second left surrounding portion 55.

The second right wall portion 52 is a portion of the right wall surface of the second housing 32 that is on a front side of the two fastening portions 601. The second right surrounding portion 53 is a portion of the right wall surface of the second housing 32 that is behind of the two fastening portions 601.

The second left wall portion 54 is a portion of the left wall surface of the second housing 32 that is on a front side of the two fastening portions 601. The second left surrounding portion 55 is a portion of the left wall surface of the second housing 32 that is behind of the two fastening portions 601.

The first right wall portion 42 and the second right wall portion 52 have an interference avoidance structure that avoids interference when they approach each other under the load. In the present embodiment, the first right wall portion 42 and the second right wall portion 52 formed as the interference avoidance structure are arranged at different positions in the thickness direction of the first right wall portion 42 and the second right wall portion 52. That is, the first right wall portion 42 and the second right wall portion 52 are arranged at different positions in the left-right direction, and there is a gap formed between the first right wall portion 42 and the second right wall portion 52 in the left-right direction. The second right wall portion 52 protrudes further to the right than the first right wall portion 42. A section of the first right wall portion 42 in the up-down direction and a section of the second right wall portion 52 in the up-down direction overlap each other in the left-right direction. The plane at which the first right wall portion 42 is located and the plane at which the second right wall portion 52 is located are substantially parallel.

The first right surrounding portion 43 supports the second right surrounding portion 53 from below. The upper end of the first right surrounding portion 43 and the lower end of the second right surrounding portion 53 are in contact with each other.

The first left wall portion 44 and the second left wall portion 54 have an interference avoidance structure that avoids interference when they approach each other under load. In the present embodiment, the first left wall portion 44 and the second left wall portion 54 formed as an interference avoidance structure are arranged at different positions in the thickness direction of the first left wall portion 44 and the second left wall portion 54. That is, the first left wall portion 44 and the second left wall portion 54 are arranged at different positions in the left-right direction, and there is a gap formed between the first left wall portion 44 and the second left wall portion 54 in the left-right direction. The second left wall portion 54 protrudes further to the left than the first left wall portion 44. The first left wall portion 44 and the second left wall portion 54 partially overlap with each other from side to side in the up-down direction. The plane at which the first left wall portion 44 is located and the plane at which the second left wall portion 54 is located are substantially parallel.

The first left surrounding portion 45 supports the second left surrounding portion 55 from below. The upper end of the first left surrounding portion 45 and the lower end of the second left surrounding portion 55 are in contact with each other.

According to the first embodiment described above, it is possible to acquire the following advantageous effects.

In the virtual image display apparatus 100, the first front wall portion 41 and the second front wall portion 51 are arranged at different positions in the front-rear direction. According to such a configuration, when the first front wall portion 41 and the second front wall portion 51 approach each other under the load, the first front wall portion 41 and the second front wall portion 51 shift back and forth and slip through each other vertically. Therefore, the virtual image display apparatus 100 slips out without interference between the first front wall portion 41 and the second front wall portion 51, so that it is possible to absorb impact at a higher degree.

The first right wall portion 42 and the second right wall portion 52 are arranged at different positions in the left-right direction. Both the first left wall portion 44 and the second left wall portion 54 are arranged at different positions in the left-right direction. According to such a configuration, as similar to the case of the first front wall portion 41 and the second front wall portion 51, it is possible to absorb impact to a higher degree.

The interference avoidance structure is formed on the front side of the housing 30. According to such a configuration, the virtual image display apparatus 100 is more likely to crumble when receiving the load from a pedestrian on the front side of the vehicle body 1 where it is most likely to run into a pedestrian. Therefore, it is possible to absorb impact at a higher degree.

The virtual image display apparatus 100 includes the two frontmost fastening portions 601 among the fastening parts 60 are provided behind the rotating shaft 203. According to such a configuration, the fastening parts 60 are not present on the front side of the virtual image display apparatus 100. Therefore, it is possible to avoid a situation in which the fastening parts 60 obstruct the tear down of the front part of the virtual image display apparatus 100.

The interference avoidance structure is formed by the first front wall portion 41, the second front wall portion 51, the first right wall portion 42 and the second right wall portion 52, and the first left wall portion 44, and the second left wall portion 54. As shown in FIG. 5, the interference avoidance structure is formed in an entire region 400 being on a front side of the two fastening portions 601. According to such a configuration, the virtual image display apparatus 100 easily slips out on the front side of the virtual image display apparatus 100, which is most susceptible to the load from a pedestrian. Therefore, it is possible to absorb impact.

The first front wall portion 41 and the second front wall portion 51 partially overlap in the up-down direction. According to such a configuration, it is possible to suppress foreign matter from entering the virtual image display apparatus 100.

The windshield 10 corresponds to a projection member. The first front wall portion 41, the first right wall portion 42, and the first left wall portion 44 portion correspond to a first wall or a first wall portion. The second front wall portion 51, the second right wall portion 52 and the second left wall portion 54 correspond to a second wall or a second wall portion. The downward direction (may also be referred to “DOWN” as illustrated in the drawings) corresponds to a first direction. The upward direction (may also be referred to “UP” as illustrated in the drawings) corresponds to a second direction. The front direction corresponds to a third direction.

### Second Embodiment

In the first embodiment, the first front wall portion 41 and the second front wall portion 51 are formed as an interference avoidance structure in which the first front wall portion 41 and the second front wall portion 51 are arranged at different positions in the front-rear direction. A second embodiment is different from the first embodiment such that the interference avoidance structure has tilted surfaces respectively at the upper end portion of the first front wall portion 71 and the lower end portion of the second front wall portion 72. The following describes the difference between a virtual image display apparatus 300 according to the second embodiment and the virtual image display apparatus 100 according to the first embodiment.

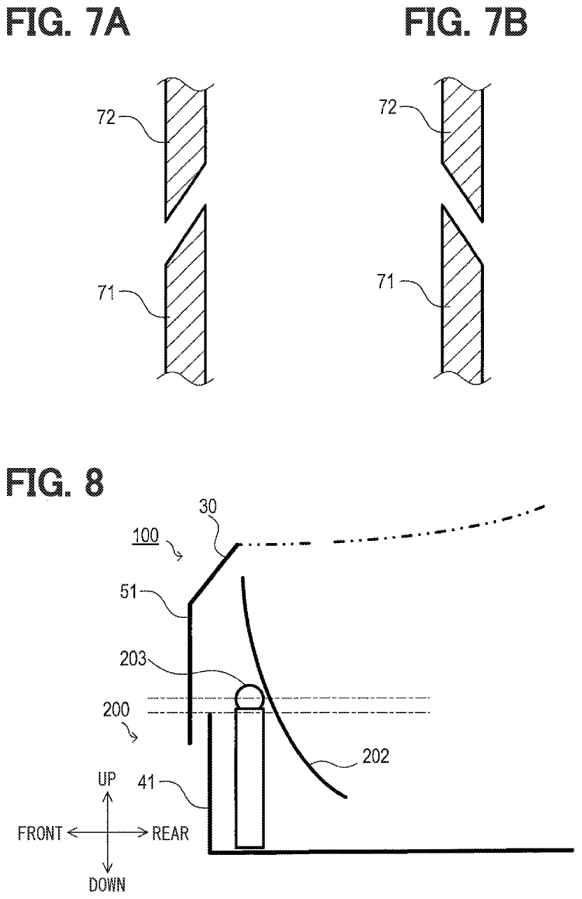

As shown in FIG. 6, the first front wall portion 71 and the second front wall portion 72 are arranged at substantially the same position in the front-rear direction. As shown in FIG. 7A, the first front wall portion 71 has a tilted surface at its upper end. The tilted surface of the first front wall portion 71 is formed so that its tip end becomes thinner from the front to the rear. The second front wall portion 72 has a tilted surface at the lower end. The tilted surface of the second front wall portion 72 is formed so that the tip end becomes thinner from the rear to the front. A gap is formed between the tilted surface of the first front wall portion 71 and the tilted surface of the second front wall portion 72.

Although not shown, similar tilted surfaces are respectively provided at the upper end of the first right wall portion 42, the lower end of the second right wall portion 52, the upper end of the first left wall portion 44, and the lower end of the second left wall portion 54.

According to the second embodiment described above, the following advantageous effects are provided in addition to the advantageous effects of the first embodiment described above.

Tilted surfaces are provided at the respective tip ends of the first front wall portion 71 and the second front wall portion 72. According to such a configuration, when the first front wall portion 71 and the second front wall portion 72 approach each other under load, they slide on the tilted surface and pass vertically. The virtual image display apparatus 300 slips out without interference between the first front wall portion 71 and the second front wall portion 72, and thus it is possible to absorb impact.

The first front wall portion 71, the first right wall portion 42, and the first left wall portion 44 correspond to a first wall or a first wall portion. The second front wall portion 72, the second right wall portion 52, and the second left wall portion correspond to a second wall or a second wall portion.

### Other Embodiments

Although the embodiments of the present disclosure have been described above, the present disclosure is not limited to the above embodiments and can take various forms.

The above embodiment describes a structure in which the fastening parts 60 are provided behind the rotation shaft 203 of the concave mirror 202. However, the positions where the fastening parts 60 are provided are not limited to the above-mentioned positions. For example, the fastening parts 60 may be provided on an extension line of the rotation shaft 203 of the concave mirror 202, or may be provided on a front side of the rotation shaft 203 of the concave mirror 202. The positions of the fastening parts 60 may be different on the left and right sides.

The first embodiment describes a structure in which the respective upper ends of the first front wall portion 41, the first right wall portion 42, and the first left wall portion 44 are located above the height of the rotation shaft 203 of the concave mirror 202. However, the positions of the upper ends of the first front wall portion 41, the first right wall portion 42, and the first left wall portion 44 are not limited to the above-mentioned positions. For example, the upper ends of the first front wall portion 41, the first right wall portion 42, and the first left wall portion 44 may be provided at substantially the same height position as the rotation shaft 203 of the concave mirror 202, or may be provided below the height position of the rotation shaft 203 of the concave mirror 202. The upper ends of the first front wall portion 41, the first right wall portion 42, and the first left wall portion 44 may have different heights. As shown in FIG. 8, when the upper end of the first front wall portion 41 is located below the height position of the rotation shaft 203, the first front wall portion 41 does not exist above the virtual image display apparatus 100. Therefore, it is possible to avoid a situation in which the first front wall portion 41 obstructs the tear down of the virtual image display apparatus 100.

Although the above embodiment describes that the interference avoidance structure is formed at the entire region 400 being on a front side of the two fastening portions 601, the interference avoidance structure may only be formed at a portion of the front part of the two fastening portions 601. Even in this situation, it is possible to further absorb impact in the interference avoidance structure.

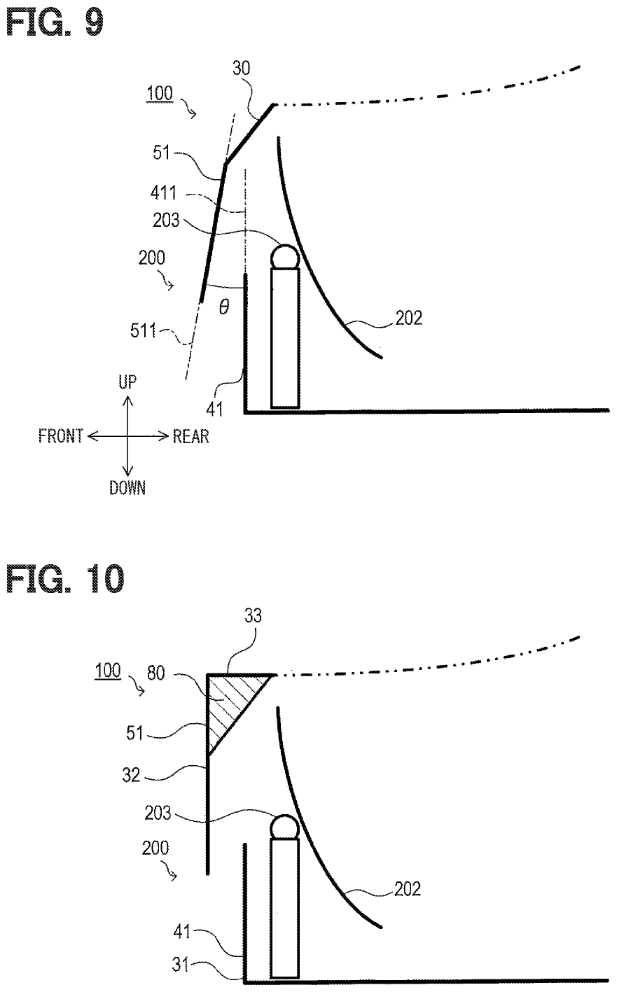

The first embodiment describes a structure in which the plane 411 on which the first front wall portion 41 is located and the plane 511 on which the second front wall portion 51 is located are substantially parallel to each other. However, as illustrated in FIG. 9, the second front wall portion 51 may be apart from the plane at which the first front wall portion 41 is located as approaching to the lower side of the second front wall portion 51. That is, the angle θ formed by the plane 411 on which the first front wall portion 41 is located and the plane 511 on which the second front wall portion 51 is located may be larger than zero degree. According to such a configuration, even if a pedestrian runs into the vehicle and a load is applied in a direction in which the first front wall portion 41 and the second front wall portion 51 approach each other, it is unlikely that the second front wall portion 51 falls towards the first front wall portion 41. Therefore, the first front wall portion 41 and the second front wall portion 51 are less likely to interfere with each other, so that the impact absorbing function can be further exhibited.

The second front wall portion 51 may be closer to the plane at which the first front wall portion 41 is located, as viewed in a direction towards the bottom of the second front wall portion 51. In this situation, it is possible to effectively inhibit the entry of foreign matter into the housing 30.

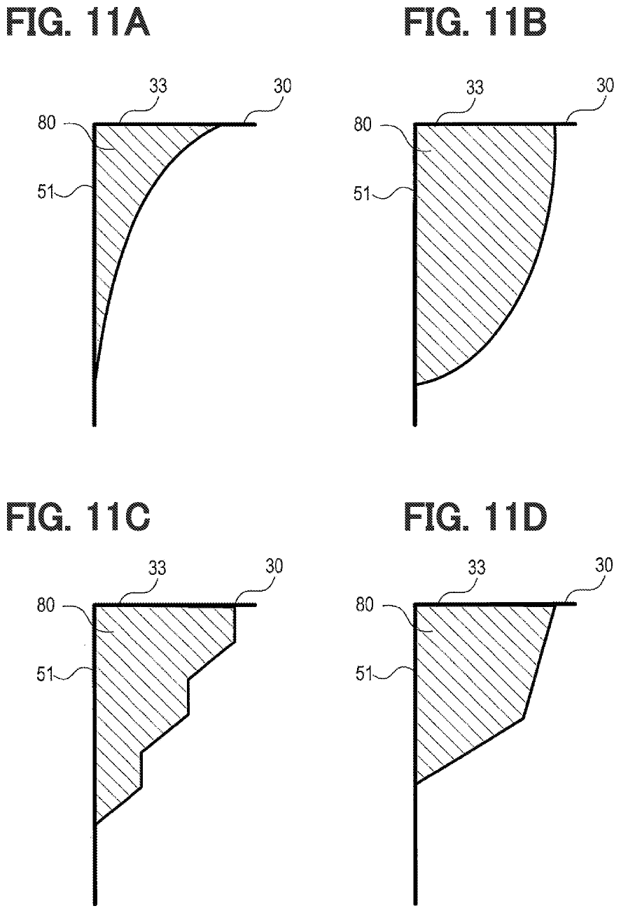

As illustrated in FIG. 10, a rib 80 may be provided from a top surface portion 33 to the second front wall portion 51 on a front side of the second housing 32. According to such a configuration, even if a pedestrian runs into a vehicle and a load is applied in a direction in which the first front wall portion 41 and the second front wall portion 51 approach each other, it is unlikely that the second front wall portion 51 falls towards the first front wall portion 41. Therefore, the first front wall portion 41 and the second front wall portion 51 are less likely to interfere with each other, so that the impact absorbing function can be further exhibited. The rib 80 may have a triangular cross section when viewed from the side, or may have a concave shape on the side facing the center of the housing 30 as shown in FIG. 11A. The rib 80 may have a convex shape on the side facing the center of the housing 30, as shown in FIG. 11B. The rib 80 may have a portion projecting towards the center of the housing 30, as shown in FIGS. 11C and 11D.

The first embodiment describes the structure in which the second front wall portion 51 protrudes further to the front than the first front wall portion 41. However, the first front wall portion 41 may protrude further to the front than the second front wall portion 51.

The second embodiment describes the structure in which: the tilted surface of the first front wall portion 71 is formed such that the tip end becomes thinner from the front to the rear; and the tilted surface of the first front wall portion 72 is formed such that the tip end becomes thinner from the rear to the front. However, the shape of the tilted surface is not limited to the shape described above. For example, as shown in FIG. 7B, the tilted surface of the first front wall portion 71 is formed so that the tip end becomes thinner from the rear to the front; and the tilted surface of the second front wall portion 72 is formed so that the tip end becomes thinner from the front to the rear.

In addition, only one of the upper end portion of the first front wall portion 71 and the lower end portion of the second front wall portion 72 may be provided with a tilted surface.

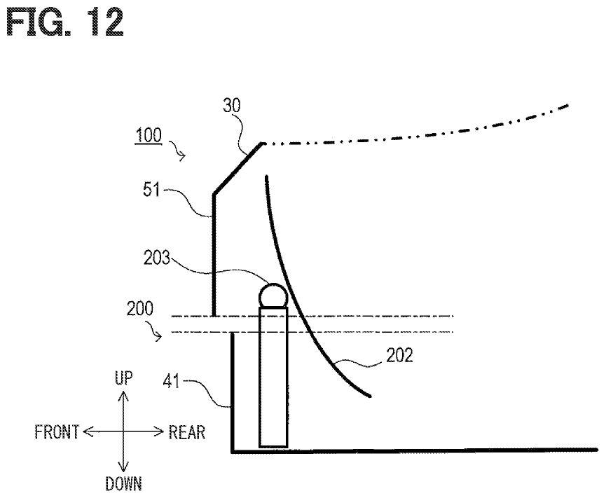

The above embodiment describes the structure in which the lower end of the second front wall portion 51 is located below the upper end of the first front wall portion 41. However, the arrangement of the upper end of the first front wall portion 41 and the lower end of the second front wall portion 51 is not limited to the above arrangement. As shown in FIG. 12, the lower end of the second front wall portion 51 may be located above the upper end of the first front wall portion 41. When the upper end of the first front wall portion 41 and the lower end of the second front wall portion 51 are arranged at positions that do not overlap in the up-down direction, the distance between the upper end of the first front wall portion 41 and the lower end of the second front wall portion 51 may be smaller than 3 millimeters.

The above embodiment describes the structure in which screws are used as the fastening parts 60. However, a member for fastening the first housing 31 and the second housing 32 may not be limited to the above member. For example, a clip may be used as a member for fastening the first housing 31 and the second housing 32. For example, the clip is in contact with the lower surface of the horizontally extending end of the first housing 31 and the upper surface of the horizontally extending end of the second housing 32, and clamps both members from above and below. For example, the first housing 31 and the second housing 32 may be locked with a claw.

The above embodiment describes the structure in which the interference avoidance structure is provided on the front side of the virtual image display apparatus 100. However, the position at which the interference avoidance structure is provided is not limited to the above position. For example, the interference avoidance structure may be provided on at least one of the right side, left side, and rear side of the virtual image display apparatus 100.

The above embodiment describes the windshield 10 as the projection member. However, the member for reflecting the display light is not limited to the above member. For example, a combiner may be used as the member for reflecting the display light.

Although the above embodiment describes the concave mirror 202 as the reflection mirror. For example, a plane mirror may be used as the reflection mirror.

Multiple functions of one configuration element in the above embodiments may be implemented by multiple configuration elements, or a single function of one configuration element may be implemented by multiple configuration elements. A part of the configuration of the above embodiments may be omitted. At least a part of the configuration in one embodiment may be added to or substituted for the configuration of another embodiment.

What is claimed is:

1. A virtual image display apparatus comprising:
a housing, wherein:
the virtual image display apparatus is configured to emit display light towards a projection member of a vehicle to allow a viewer to visually recognize the display light as a virtual image reflected by the projection member;
the housing includes
a first housing part located on a side of the housing facing in a first direction, and
a second housing part located on a side of the housing facing in a second direction being opposite to the first direction, and
a composite wall located on a side of the housing facing in a third direction being perpendicular to the first direction, the composite wall including a first wall portion and a second wall portion, the first wall portion extending from the first housing part, the second wall portion extending from the second housing part; and
the first wall portion and the second wall portion have an interference avoidance structure that is configured to avoid interference when the first wall portion and the second wall portion approach each other by receiving a load.

2. The virtual image display apparatus according to claim 1,
wherein the interference avoidance structure is a structure in which the first wall portion and the second wall portion are at different positions in a thickness direction of the first wall portion and the second wall portion.

3. The virtual image display apparatus according to claim 1, wherein:
the first wall portion has a tip facing in the second direction, and the second wall portion has a tip facing in the first direction; and
the interference avoidance structure is a structure in which at least one of the tip of the first wall portion or the tip of the second wall portion has a tilted surface.

4. The virtual image display apparatus according to claim 1, further comprising:
a reflection mirror located inside the housing, the reflection mirror reflecting the display light towards the projection member; and
at least one fastening portion fastening the first housing part and the second housing part, wherein:
the composite wall faces in a frontward direction of the vehicle; and
a rotation shaft of the reflection mirror is located between the at least one fastening portion and the composite wall without any member fastening the first housing part and the second housing part between the composite wall and the rotation shaft.

5. The virtual image display apparatus according to claim 1, further comprising:
a reflection mirror located inside the housing, the reflection mirror reflecting the display light towards the projection member, wherein:
the second housing part is located above the first housing part; and
the first wall portion has a tip facing in the second direction, and the tip is located below a height position of a rotation shaft of the reflection mirror.

6. The virtual image display apparatus according to claim 1, further comprising:
one or a plurality of fastening portions fastening the first housing part and the second housing part; and
at least one fastening portion fastening the first housing part and the second housing part, wherein:
the composite wall faces in a frontward direction of the vehicle;
the at least one fastening portion includes a frontmost fastening portion located at a position frontmost among the at least one fastening portion in the frontward direction; and
the interference avoidance structure extends in an entire region of the composite wall on a front side of the frontmost fastening portion.

7. The virtual image display apparatus according to claim 1,
wherein the second wall portion separates away from a plane on which the first wall portion is located in a direction toward a tip of the second wall portion facing in the first direction.

8. The virtual image display apparatus according to claim 1,
wherein the second housing part is located above the first housing part, the virtual image display apparatus comprising:
a rib extending from a top portion having an upper surface of the second housing part to the second wall portion.

9. The virtual image display apparatus according to claim 1, wherein:
the first wall portion has a tip facing in the second direction, and the second wall portion has a tip facing in the first direction; and
a distance between the tip of the first wall portion and the tip of the second wall portion is smaller than 3 millimeters, in a case where the tip of the first wall portion and the tip of the second wall portion do not overlap each other in the first direction.

10. The virtual image display apparatus according to claim 1,
wherein the housing is open on the composite wall.
